(19) United States
(12) Patent Application Publication
(10) Pub. No.: US 2007/0242381 A1
(43) Pub. Date: Oct. 18, 2007

(54) Magnetic recording medium and magnetic recording/reproducing device

(75) Inventors: Masatoshi Sakurai, Tokyo (JP); Yoshiyuki Kamata, Tokyo (JP); Satoshi Shirotori, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/723,758

(22) Filed: Mar. 21, 2007

(30) Foreign Application Priority Data
Mar. 31, 2006 (JP) P2006-100040

(51) Int. Cl. G11B 5/09

(52) U.S. Cl. 360/48

(57) ABSTRACT

A magnetic recording medium includes: a data area where data is to be recorded; and a servo area where position signal for positioning a recording/reproducing head is recorded, the servo area being provided with an address section in which address information is recorded, wherein the address section has a magnetic pattern configured by columns of recording portions, the columns being arranged in a direction that intersects with a direction of recording tracks to be in parallel with one another, and by non-recording portions arranged between the columns.

### RELATED APPLICATION(S)

The present disclosure relates to the subject matter contained in Japanese Patent Application No. 2006-100040 filed on Mar. 31, 2006, which is incorporated herein by reference in its entirety.

### FIELD

The present invention relates to a patterned servo-type magnetic recording medium in which a servo portion is patterned by presence and absence or concavities and convexities of a magnetic body and a magnetic recording device including the magnetic recording medium.

### BACKGROUND

In association with increase in capacity of a magnetic recording device, a magnetic disk device and a hard disk drive device, a recording density required for a magnetic recording medium increases. Therefore, it is highly likely that magnetic information recorded by a magnetic recording/reproducing head which relatively moves on the magnetic recording medium adversely affects record in an adjacent track. In order to avoid such an adverse effect, physical separation of magnetic bodies in the adjacent tracks is considered. In this manner, a medium provided with a pattern of presence and absence of the magnetic body or of the magnetic body and a non-magnetic body in a form of a recording track or a recording bit on the magnetic recording medium is referred to as a patterned medium.

By the relative movement of the magnetic recording/reproducing head on a surface of the magnetic recording medium, magnetic data is recorded to and reproduced from a desired position on the surface of the medium.

In order to allow the magnetic recording/reproducing head to move to a desired position on the recording medium, a positioning servo area exists on the magnetic recording medium. From a position signal obtained from a reproducing head when the recording/reproducing head moves across the servo area at the time of recording and reproducing, the position of the recording/reproducing head on the recording medium is obtained. From the obtained positional information, the position of a recording/reproducing device is controlled to move the recording head to a desired recording position.

In the patterned medium, it is preferable to form the signal of the servo area together with a data area as a magnetic body pattern in terms of reduction of manufacturing cost of the medium, and to form a servo positioning signal and a recording pattern together in terms of high positioning accuracy. A medium in which the servo area is manufactured as the magnetic body pattern is specifically referred to as a patterned servo medium.

The patterned medium or the patterned servo medium is fabricated by using, for example, a nano-imprint process. For example, in a medium having a pattern of the magnetic body and the non-magnetic body, a nano-imprint stamper having a pattern of concavities and convexities is pressed against a resist film applied on a magnetic film to transfer the pattern of convexities and concavities to the resist film. Thereafter, the magnetic body under the resist film is patternized using the resist film to which the pattern of convexities and concavities is transferred as a mask. Therefore, the quality of a pattern shape of the magnetic body is affected by the quality of the pattern of concavities and convexities formed on the resist film.

A magnetic pattern shape of a servo area used in a general HDD will be described.

The servo area includes at least a preamble area, an address area, and a positioning burst area (or a burst area).

The address area includes track number or sector number information, and indicates a track position where a head is located. Address information is written with a gray code so that the data can be read out even when the head is shifted to the adjacent track while seeking.

An example pattern of the address area in the related art is shown in U.S. Pat. No. 6,643,082 B1. In the patterned servo medium, a pattern shown in FIG. 17 is fabricated as a pattern of the magnetic body and the non-magnetic body or a pattern of concavities and convexities of the magnetic body. Since the patterns indicating the addresses are adjacent to each other in the respective columns of the patterned servo medium in the related art, a stepped portion (within a broken line) as shown in FIG. 17 exists.

However, in order to form the address area on the patterned servo medium, a resist film having the pattern shown in FIG. 17 as a pattern of concavities and convexities must be fabricated by means of the nano-imprint process or the like. However, when forming the stepped portion in a pattern of concavities and convexities shown in FIG. 17 on the resist film as an address area, edges of the stepped portion may be rounded as shown in FIG. 18 due to deformation by a surface tension of the resist. When the edges of the stepped portion in the pattern of concavities and convexities of the resist film are rounded, the rounded shape is transferred to the magnetic pattern obtained in the subsequent process. Therefore, after having assembled the medium to the recording/reproducing device, the positioning accuracy of the recording/reproducing head may be deteriorated, and hence a reproducing margin when reproducing the data may be reduced.

### SUMMARY

According to a first aspect of the invention, there is provided a magnetic recording medium including: a data area where data is to be recorded; and a servo area where position signal for positioning a recording/reproducing head is recorded, the servo area being provided with an address section in which address information is recorded, wherein the address section has a magnetic pattern configured by columns of recording portions, the columns being arranged in a direction that intersects with a direction of recording tracks to be in parallel with one another, and by non-recording portions arranged between the columns.

According to a second aspect of the invention, there is provided a magnetic recording/reproducing device including: a magnetic recording medium; and a magnetic recording/reproducing head reading and writing data from and onto the magnetic recording medium, wherein the magnetic recording medium includes: a data area where data is to be recorded; and a servo area where position signal for positioning a recording/reproducing head is recorded, the servo area being provided with an address section in which address information is recorded, wherein the address section has a magnetic pattern configured by columns of recording portions, the columns being arranged in a direction that intersects with a direction of recording tracks to be in parallel with one another, and by non-recording portions arranged between the columns, and wherein the magnetic recording/reproducing head reads the address information recorded in the servo area.

### BRIEF DESCRIPTION OF THE DRAWINGS

In the accompanying drawings:

FIG. 1 is a plan view of a servo area in a magnetic recording medium according to an embodiment of the invention;

FIG. 2 is a cross-sectional view taken along the line II-II in FIG. 1;

FIG. 3 is a cross-sectional view taken along the line II-II in FIG. 1;

FIG. 4 is a drawing showing a manufacturing process of the magnetic recording medium in Example 1;

FIG. 5 is a drawing showing the manufacturing process of the magnetic recording medium in Example 1;

FIG. 6 is a drawing showing the manufacturing process of the magnetic recording medium in Example 1;

FIG. 7 is a drawing showing the manufacturing process of the magnetic recording medium in Example 1;

FIG. 8 is a drawing showing the manufacturing process of the magnetic recording medium in Example 1;

FIG. 9 is a drawing showing the manufacturing process of the magnetic recording medium in Example 1;

FIG. 10 is a drawing showing a manufacturing process of the magnetic recording medium in Example 2;

FIG. 11 is a drawing showing the manufacturing process of the magnetic recording medium in Example 2;

FIG. 12 is a drawing showing the manufacturing process of the magnetic recording medium in Example 2;

FIG. 13 is a drawing showing the manufacturing process of the magnetic recording medium in Example 2;

FIG. 14 is a drawing showing the manufacturing process of the magnetic recording medium in Example 2;

FIG. 15 is a drawing showing the manufacturing process of the magnetic recording medium in Example 2;

FIG. 16 is a conceptual drawing showing a configuration of the magnetic recording/reproducing device in Example 3;

FIG. 17 is a plan view of a servo area of a patterned servo medium in the related art; and

FIG. 18 is an enlarged drawing of a stepped portion shown in FIG. 17.

### DETAILED DESCRIPTION OF THE EMBODIMENT(S)

Referring now to the drawings, an embodiment of the invention will be described.

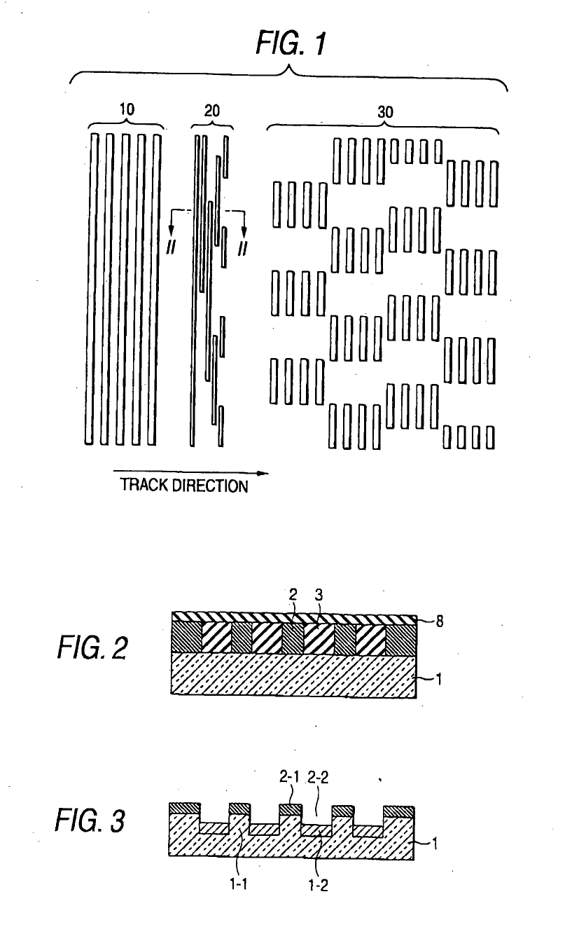

A plan view of a servo area in a magnetic recording medium according to the embodiment is shown in FIG. 1. The servo area roughly includes a preamble section 10, an address section 20 and a deviation detecting burst section (hereinafter referred to as a burst section) 30, and is formed as a recording/non-recording pattern as in a data area.

The preamble section 10 is provided for performing PLL (Phase Locked Loop) processing for synchronizing a servo signal reproduction clock for the time lag generated by the deviation of rotation of the media or AGC (Auto Gain Control) processing for maintaining signal reproduction amplitude to an adequate value. It is configured in a pattern of repetition of recording/non-recording in a circumferential direction of the media (magnetic disk) so as to continue in a substantially arcuate radial pattern which is not divided in a radial direction of the media. An individual linear magnetic pattern is divided in a cycle according to the width and a skew angle of the reproducing head.

The address section 20 includes non-recording portions between adjacent columns therein for separating the pattern. A servo signal recognizing code referred to as a servo mark, sector information, cylinder information, and so on are formed at the same pitch as the circumferential pitch of the preamble section with Manchester code. In particular, since the cylinder information has a pattern in which the information varies from servo track to servo track, it is converted first into a gray code which minimizes the variation from the adjacent tracks and then converted into Manchester code to record in order to minimize the influence of an erroneous address interpretation during seeking operation.

The grey code is a modified binary code in which sequential numbers are represented by expressions that differ only in one bit, to minimize errors.

The burst section 30 is an off-track detection area for detecting the off-track amount from an on-track state of a cylinder address, and is formed with four marks shifted in pattern phase in the radial direction referred to as A, B, C and D bursts. The respective bursts include a plurality of marks at the same pitch cycle as the preamble section 10 in the circumference direction, and the radial cycle is proportional to the cycle of variation of the address pattern, in other words, proportional to the servo track cycle. In this embodiment, the burst section 30 has a pattern in which the bursts are formed ten cycles in the circumference direction, and repeated in cycles of twice the length of the servo track cycle in the radial direction. The shape of the mark is basically set out to be a square shape, more accurately, to be a parallelogram taking the skew angle at the time of head access. However, due to the machining accuracy of the stamper or the machining performances such as transfer and formation, the mark has somewhat rounded shape. The mark portion is formed as a non-magnetic portion. Although the principle of position sensing from the burst section 30 will not be described in detail, the average amplitude value of the A, B, C and D burst sections reproduction signal is computed to calculate the off-track amount.

FIGS. 2 and 3 are cross-sectional views taken along the line II-II shown in FIG. 1. As shown in FIGS. 2 and 3, the address section 20 also has a pattern in which recording portions 2 and non-recording portions 3 are alternately repeated as in other sections. The recording portions 2 and the non-recording portions 3 may be configured roughly in two patterns; the pattern of presence and absence of the magnetic body shown in FIG. 2 and the pattern of concavities and convexities of the magnetic body shown in FIG. 3.

The pattern in the address section 20 in the invention is such that the respective columns of the pattern are separated by the non-recording portion 2-2, 3 as shown in FIG. 1. Therefore, a stepped portion does not exist. Accordingly, since the blunting of the stepped pattern of the magnetic recording medium in the related art as shown in FIG. 17 does not exist in the address pattern in the invention, the magnetic recording/reproducing device employing the magnetic recording medium having the address pattern in the invention does not suffer from the positioning accuracy as described above, and hence the positioning of the magnetic recording/reproducing head with high degree of accuracy is achieved.

When the widths of the non-recording portions 2-2, 3 between the columns are too large, the surface area of the address area increases, whereby the information recording area of the medium is constrained thereby decreasing the recording capacity. In contrast, when they are too small, the above-described problem caused at the stepped portion between the adjacent columns is liable to occur and, in addition, the pattern pitch is reduced, so that a blunting of pattern due to narrower aspect of the pattern may occur. Therefore, the adequate width must be selected. More specifically, the width of the sum of the pattern (recording portions 2, 2-1) in the address section 20 and the non-recording portions 2-2, 3 is preferably the same pitch as the circumferential pitch of the preamble section 10. The width of the separating portion with respect to the pattern area of each column of the address section 20 is preferably between 50% and 100%.

As described above, the magnetic recording medium according to the embodiment has: the data area where data is to be recorded; and the servo area where position signal for positioning a recording/reproducing head is recorded, the servo area being provided with the address section 20 in which address information is recorded. The address section 20 has a magnetic pattern configured by columns of recording portions 2, the columns being arranged in a direction that intersects with a direction of recording tracks to be in parallel with one another, and by non-recording portions 3 arranged between the columns.

The direction of recording tracks is shown by an arrow “Track Direction” in FIG. 1 (and in FIG. 17).

### EXAMPLE 1

Referring now to FIG. 2, the magnetic recording medium as Example 1 will be described FIG. 2 is a cross-sectional view taken along the line II-II in FIG. 1, showing a pattern of presence and absence of the magnetic body

As shown in FIG. 2, in the pattern of presence and absence of the magnetic body, the recording portion 2 includes the magnetic body whereby the magnetic information can be recorded and reproduced by the magnetic recording/reproducing head, and a magnetic body film of the non-recording portion 3 which reproduce the magnetic information by the recording/reproducing head is thinner than the thickness of a magnetic body film of the recording portion or does not exist. The magnetic recording medium having such a pattern is referred to as a magnetic body machined medium. In the case of a magnetic recording medium of a vertically recording system, when the medium is magnetized in the direction vertical to the medium surface, magnetized information can be obtained from the recording portion 2, but magnetized information cannot be obtained from the non-recording portion 3.

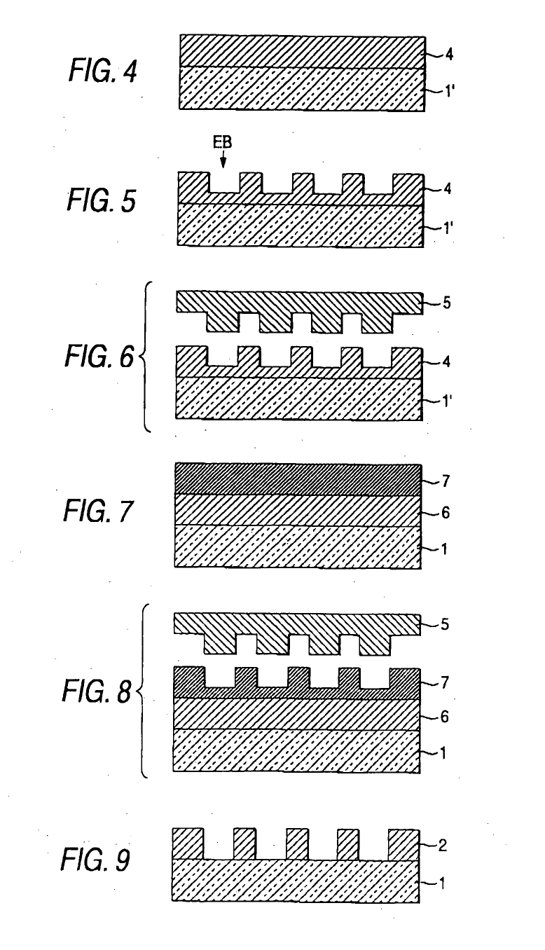

Referring to FIGS. 4 to 9, a method of manufacturing the magnetic recording medium according to this example will be described.

As shown in FIG. 4, resist 4 is applied on a substrate 1 by a thickness on the order of 50 nm. The substrate 1 is preferably a Si substrate or a glass substrate. The resist 4 is a resist for drawing with an electron beam.

Subsequently, as shown in FIG. 5, the magnetic body pattern is formed as concavities and convexities of the resist 4 by drawing the magnetic body pattern of the invention with the electron beam and carrying out developing processing. At this time, the structure shown in FIG. 1, in which the adjacent address patterns are separated is formed. The width of the separation is preferably between 50% and 100% with respect to the pattern area of each column as described above.

As shown in FIG. 6, after having formed the magnetic body pattern, a stamper 5 is obtained by electrocasting the resist pattern obtained in FIG. 5. The material of the stamper 5 is preferably Ni or alloy thereof, but is not limited thereto. For example, metal such as Ti, Al, or allow thereof, or quartz are also applicable. Concavities and convexities of the stamper are formed by inversely transferring the concavities and convexities of the resist. Although not shown, it is also possible to obtain the stamper by etching a surface of the substrate 1 corresponding to the concavities and convexities of the resist and transferring the same.

As shown in FIG. 7, after having formed the stamper 5, the resist 4 is removed, and a ferromagnetic layer 6 for magnetic recording is formed on the substrate 1 by a thickness on the order of 20 nm. The ferromagnetic layer 6 is preferably a material suitable to vertical recording such as CoCrPt. Although not shown, it is preferable to form a base layer formed of soft magnetic material before forming the ferromagnetic layer 6. After having formed the ferromagnetic layer 6, the imprinting resist is applied by a thickness on the order of 40 nm thereon to form a resist film 7.

As shown in FIG. 8, after having formed the resist film 7, the stamper 5 fabricated in the process in FIG. 6 is placed so as to oppose the resist film 7, and the stamper 5 and the resist film 7 are pressed to each other with a pressure according to an imprinting method, so that the pattern of concavities and convexities on the surface of the stamper 5 is transferred to a surface of the resist film 7. After having transferred, the stamper 5 is peeled off.

As shown in FIG. 9, after having transferred the pattern of concavities and convexities, the resist film 7 formed with the pattern of concavities and convexities by the process in FIG. 8 is used as a mask, and the ferromagnetic layer 6 underneath is etched, whereby the ferromagnetic layer 6 is patterned according to the pattern of concavities and convexities on the surface of the resist film 7 to form the recording portion 2.

Finally, the non-recording portions 3 are formed by forming the non-magnetic body in the recesses between the recording portions 2, then, a protective layer 8 formed of DLC (Diamond-like Carbon) or the like and a lubricating layer, not shown, are formed on upper surfaces of the recording portions 2 and the non-recording portions, whereby the magnetic recording medium shown in FIG. 2 is completed.

In the manufacturing method described above, the magnetic recording medium having the structure in which the adjacent address patterns are separated is fabricated. Therefore, in this manufacturing method, the problem that the edges of the stepped portion of the address pattern are rounded by the deformation of the resist can be avoided.

### EXAMPLE 2

Referring now to FIG. 3, the magnetic recording medium as Example 2 will be described. FIG. 3 is a cross-sectional view taken along the line II-II shown in FIG. 1 as FIG. 2, showing a pattern of concavities and convexities of the magnetic body.

As shown in FIG. 3, in the pattern of concavities and convexities of the magnetic body, a substrate convexity 1-1 exists in the recording portion 2 of the magnetic recording medium, and a magnetic body which can record and reproduce the magnetic information by the magnetic recording/reproducing head is formed thereon. This part is referred to as the recording portion 2-1. The non-recording portion includes a substrate concavity 1-2, and s magnetic body which can record and reproduce the magnetic information by the magnetic recording/reproducing head is formed thereon. This part is referred to as the non-recording portion 2-2. The magnetic recording medium having such a pattern is referred to as a substrate patterned medium. When assembling such a magnetic recording medium into the magnetic recording/reproducing device, the magnetic recording/reproducing head can record and reproduce the magnetic information with respect to a magnetic body convexity, while the magnetic information cannot be recorded and reproduced with respect to a magnetic body concavity because the distance from the magnetic recording/reproducing head is longer than that from the convexity.

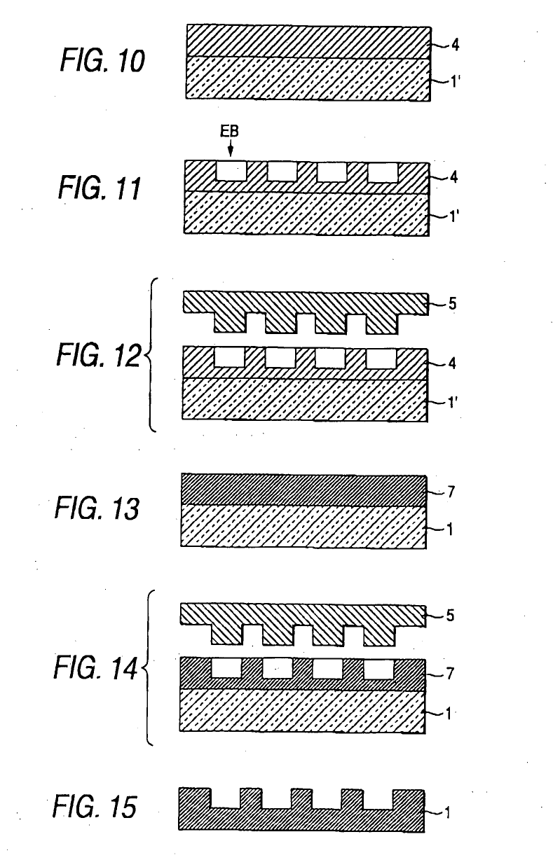

Referring to FIGS. 10 to 15, a method of manufacturing the magnetic recording medium according to this example will be described.

Since the process until the stamper 5 is fabricated (FIGS. 10 to 12) is the same as the manufacturing method in Example 1, the same reference numerals are designated in the drawing and the description thereof will be omitted.

After having formed the stamper, the resist 4 is removed and a new imprinting resist film 7 is applied again on the substrate 1 as shown in FIG. 13.

As shown in FIG. 14, after having formed the resist film 7, the stamper 5 fabricated in the process until FIG. 12 is placed so as to oppose the resist film 7, and the stamper 5 and the resist film 7 are pressed to each other with a pressure according to the imprinting method, so that the pattern of concavities and convexities on the surface of the stamper 5 is transferred to the surface of the resist film 7. After having transferred, the stamper 5 is peeled off.

As shown in FIG. 15, after having transferred the pattern of concavities and convexities, the resist film 7 on which the pattern of concavities and convexities is formed in the process in FIG. 14 is used as a mask, and the surface of the substrate 1 underneath is etched, whereby the surface of the substrate 1 is patterned according to the pattern of concavities and convexities on the surface of the resist film 7.

Finally, as shown in FIG. 3, a ferromagnetic layer for magnetic recording is formed on the substrate 1 on which the concavities and convexities are formed on the surface thereof by a thickness on the order of 20 nm. Part of the formed ferromagnetic layer which is formed on the substrate convexities 1-1 corresponds to the recording portions 2-1 and the ferromagnetic layer formed in the substrate concavities 1-2 corresponds to the non-recording portions 2-2 The ferromagnetic layer is preferably a material suitable for the vertical recording, such as CoCrPt. Although not shown, it is preferable to form a base layer formed of a soft magnetic material before forming the ferromagnetic layer. Then, the protective layer (not shown) formed of DLC (Diamond-like Carbon) or the like and a lubricating layer (not shown) are formed on the upper surfaces of the recording portions 2-1, whereby the magnetic recording medium shown in FIG. 3 is completed.

In the above-described manufacturing method, the magnetic recording medium having the structure in which the adjacent address patterns are separated is fabricated. Therefore, as in Example 1, the problem that the edges of the stepped portion of the address pattern are rounded by the deformation of the resist can be avoided in this manufacturing method.

### EXAMPLE 3

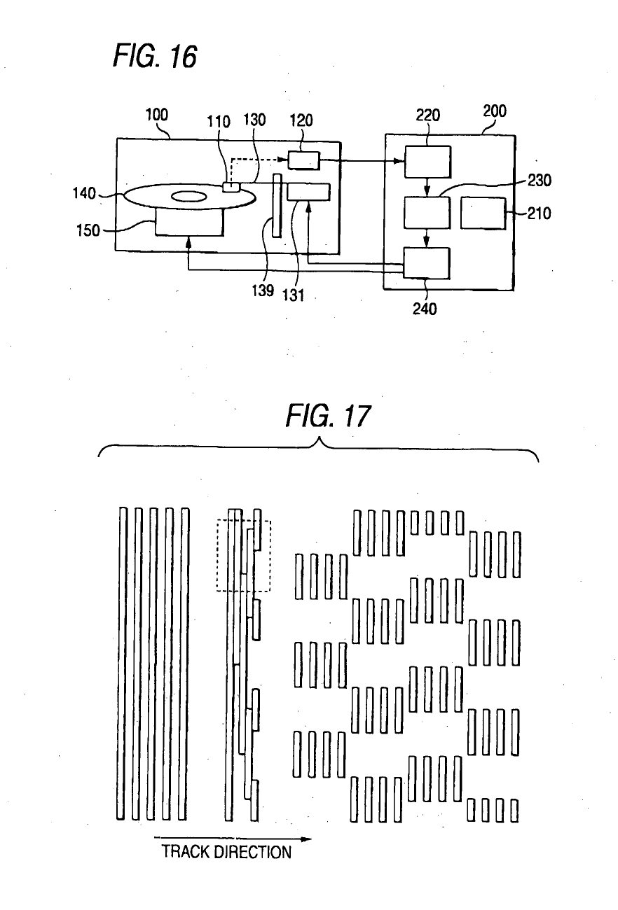

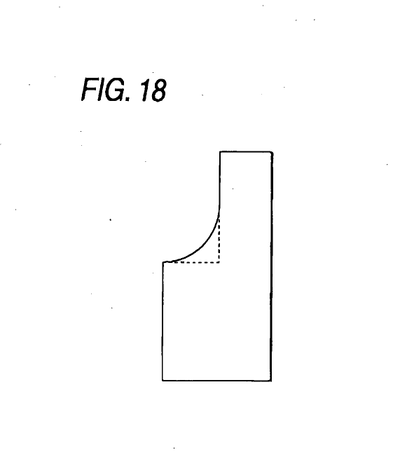

Subsequently, referring to FIG. 16, a configuration of the magnetic recording/reproducing device in the present invention will be described.

FIG. 16 is a conceptual drawing showing a configuration of one magnetic recording/reproducing head. The magnetic recording/reproducing device in the invention records and reproduces information on both front and back sides of one piece of the magnetic recording medium with two of the magnetic recording/reproducing heads. Therefore, down head/upper head are provided respectively corresponding to the front and back sides of the magnetic recording medium. The configuration of the magnetic recording/reproducing device is basically the same as in the related art except for the point that the magnetic recording medium is the medium in the invention.

The magnetic recording/reproducing device in the invention includes a main body portion also referred to as a head disc assembly (HDA) 100 and a printed circuit board (PCB) 200 as shown in FIG. 16.

The HDA 100 includes a magnetic recording medium 140, a spindle motor (SPM) 150 for rotating the magnetic recording medium 140, a magnetic recording/reproducing head 110, a head moving mechanism, and a head amplifier (HIC) 120 as shown in FIG. 16.

The magnetic recording/reproducing head 110 includes a magnetic head element having a read element (magneto-resistive element, not shown) and a write element (not shown) mounted to a slider (ABS, not shown) as a head body, and is mounted to the head moving mechanism.

The head moving mechanism includes a suspension arm 130 for supporting the magnetic recording/reproducing head, a pivot shaft 139 for rotatably supporting the suspension arm 130, and a voice coil motor (VCM) 131. The VCM 131 causes the suspension arm 130 to generate a rotational torque about the pivot shaft 139 to rotate the magnetic recording/reproducing head 110 in the radial direction of the magnetic recording medium. In addition, the HIC 120 for amplifying an input/output signal from/to the magnetic recording/reproducing head 110 is fixed to an arm and is electrically connected to the PCB 200 with a flexible cable (FPC).

In this embodiment, the configuration in which the HIC 120 is installed on the head moving mechanism for reducing the signal/noise ratio in the magnetic recording/reproducing head signal is employed. However, the invention is not limited thereto, and may exist in the PCB 200, for example.

The magnetic recording medium 140 is mounted on the spindle motor (SPM) 150. The magnetic recording medium 140 has the front side and the back side as described above, and a head movement track of the magnetic recording/reproducing device and the arcuate shape of the serve area pattern of the magnetic recording medium are assembled thereto in the substantially identical front and back direction. A specification of the magnetic recording medium 140 complies with the outer diameter and the inner diameter which are suitable for a drive, and the recording/reproducing characteristics as in the related art as a matter of course.

The PCB mainly includes four systems LSIs; a disk controller (HDC) 210, a read/write channel IC 220, an MPU 230 and a motor driver IC 240 mounted thereon.

The MPU 230 is a control unit for a magnetic recording/reproducing device drive system, and includes a ROM, a RAM, a CPU and a logic processing unit (not shown) which realizes a magnetic recording/reproducing head position controlling system according to this example The logic processing unit is a processing unit including a hardware circuit, and is used for the high-speed processing. Operating software (FW) is stored in the ROM, and the MPU 230 controls the magnetic recording/reproducing device according to the FW.

The HDC 210 is an interface in the magnetic recording/reproducing device, and serves as an interface between the magnetic recording/reproducing device and a host device (for example, a personal computer), or performs information exchange with the MPU 230, the read/write channel IC 220 and the motor driver IC 240 to control the entire magnetic recording/reproducing device.

The read/write channel IC 220 is a head signal processing unit relating to read/write operation, and is composed of a circuit for switching an HIC channel or processing recording/reproducing signals such as the read/write operation.

Restoration of a modulation system A for reading information A recorded in the patterned portion in the invention, additional recording of information B using a modulation system B in the patterned portion, and restoration on the basis of the modulation system B of the added information B are carried out in the read/write channel IC 220.

The motor driver IC 240 is a driving driver unit of the VCM 131 and the SPM 150 for controlling the drive of the SPM 150 to a constant rotation, or providing the amount of operation of VCM from the MPU 230 to the VCM as a current value to drive the head moving mechanism.

As described above, in this example, since the magnetic recording medium shown in Examples 1 and 2 is employed, the higher positioning accuracy than the magnetic recording/reproducing device in which the magnetic recording medium in the related art is mounted is obtained.

For example, a magnetic recording medium having a servo pattern of a servo pitch of 200 nm on a 1.8-inch disk and having an address structure in the related art, and a magnetic recording medium having the same servo pattern and having the address structure in the invention are fabricated, and the servo tracking accuracy is measured on the magnetic recording/reproducing device. The positioning accuracy was 10 nm at 3σ with the magnetic recording medium having the address structure in the related art, while the positioning accuracy was 7 nm at 3σ with the magnetic recording medium having the address structure of the present invention, which was higher positioning accuracy in comparison with the magnetic recording medium having the address structure in the related art.

The present invention is not limited to the above-described embodiments as is, and the components may be modified and embodied without departing the scope of the invention in the stage of implementation. In addition, the invention may be implemented in various forms by combining the plurality of components disclosed in the above-described embodiments adequately. For example, some of the components out of all the components shown in the embodiments may be eliminated. Furthermore, the components in the different embodiments can be combined as needed.

What is claimed is:

1. A magnetic recording medium comprising:
a data area where data is to be recorded; and
a servo area where position signal for positioning a recording/reproducing head is recorded, the servo area being provided with an address section in which address information is recorded,
wherein the address section has a magnetic pattern configured by columns of recording portions, the columns being arranged in a direction that intersects with a direction of recording tracks to be in parallel with one another, and by non-recording portions arranged between the columns.

2. The magnetic recording medium according to claim 1, wherein the magnetic pattern is formed by a magnetic recording layer being configured to have portions different in thickness.

3. The magnetic recording medium according to claim 1, wherein the magnetic pattern is formed on the concave and convex pattern on a substrate.

4. A magnetic recording/reproducing device comprising:
a magnetic recording medium; and
a magnetic recording/reproducing head for reading and writing data from and onto the magnetic recording medium,
wherein the magnetic recording medium comprises:
a data area where data is to be recorded; and
a servo area where position signal for positioning a recording/reproducing head is recorded, the servo area being provided with an address section in which address information is recorded,
wherein the address section has a magnetic pattern configured by columns of recording portions, the columns being arranged in a direction that intersects with a direction of recording tracks to be in parallel with one another, and by non-recording portions arranged between is the columns, and
wherein the magnetic recording/reproducing head reads the address information recorded in the servo area.

5. The magnetic recording/reproducing device according to claim 4, wherein the address information includes gray code.

6. The magnetic recording/reproducing device according to claim 4, wherein the magnetic pattern is formed by a magnetic recording layer being configured to have portions different in thickness.

7. The magnetic recording/reproducing device according to claim 4, wherein the magnetic pattern is formed on the concave and convex pattern on a substrate.
